(19) United States
(12) Patent Application Publication
(10) Pub. No.: US 2013/0323513 A1
(43) Pub. Date: Dec. 5, 2013

(54) Metalizable Oriented Polypropylene Films With A Functionalized Tie Layer Material

(71) Applicant: EXXONMOBIL CHEMICAL PATENTS INC., Baytown, TX (US)

(72) Inventors: Michael A. Hubbard, Stillwater, OK (US); Robert G. Peet, Pittsford, NY (US); Eric W. Bender, Fairport, NY (US); Jay K. Keung, Humble, TX (US); JoAnn H. Squire, Bloomfield, NY (US)

(21) Appl. No.: 13/867,315

(22) Filed: Apr. 22, 2013

Related U.S. Application Data
(60) Provisional application No. 61/653,682, filed on May 31, 2012.

(51) Int. Cl. B32B 15/085; B05D 5/00; B32B 27/08

(52) U.S. Cl. CPC B32B 15/085; B32B 27/08; B05D 5/00
USPC 428/424.2; 428/516; 428/483; 428/518; 428/476.9; 428/476.1; 428/461; 427/299

(57) ABSTRACT

Described is a multi-layered film comprising a core layer comprising polypropylene; a metalizable skin layer such as a treated HDPE or PETG; and a first tie layer comprising a functionalized polypropylene such as an acid-grafted isotactic polypropylene between the core layer and metalizable skin layer; wherein the metalizable skin layer comprises a polymer having a surface energy (ASTM D2578) of at least 30 dynes/cm, a Young's Modulus (ASTM D790) of at least 1500 MPa, and a melting point (ASTM D3418) of at least 130° C.; and wherein the film as measured on the metalizable skin side has a Haze of less than 1000 Haze Units, and a Gloss of greater than 300 Gloss Units.

### CROSS-REFERENCE TO RELATED APPLICATION

This application claims priority to and the benefit of U.S. Ser. No. 61/653,682, filed May 31, 2012, incorporated herein by reference in its entirety.

### FIELD OF THE INVENTION

The present invention is directed to multi-layered films that are metalizable. In particular, the invention(s) disclosed herein are directed to an improved appearance of the metalized multi-layered film and improved adhesive strength between the skin layers of the film and the rest of the structure.

### BACKGROUND OF THE INVENTION

It is desirable in food packaging to have an aesthetically pleasing outer appearance. In food packaging that includes metalized films, this can mean a high degree of reflectivity or “shininess”. It would be desirable to improve, or at least be able to predict, the degree of shininess in a metalized film. Relevant art in this area includes U.S. Pat. No. 6,221,191; U.S. Pat. No. 5,637,366; U.S. Pat. No. 5,324,467; U.S. Pat. No. 6,472,081; U.S. Pat. No. 6,165,610; DE 0220619; DE 0220620; DE 0220621; and EP 0 444 340. The inventor has unexpectedly observed that the appearance of metalized oriented polypropylene films is dependent upon the grade and type of polymer used in the outer or “metalizable” skin layer of the film.

It is also desirable in packaging and labels for articles that the metalizable skin layer adhere strongly to the underlying layer(s) of film, as most “films” are actually comprised of multiple layers of materials, such as a skin/tie layer/core structure. The tie layer facilitates the adhesion of the skin layer to the rest of the structure. Relevant art in this area includes U.S. Pat. No. 6,362,306; U.S. Pat. No. 5,637,366; U.S. Pat. No. 5,324,467; U.S. Pat. No. 5,041,338; US 2009/0291284; WO 2010/008696; WO 2012/039856. The inventor has unexpectedly found that the composition of the tie layer makes a significant difference in the strength of the skin layer adhesion to the film structure.

The present invention is directed to achieving both an improved “shiny” appearance to the film and improved lamination peel strength of the metalizable skin layer of the multi-layered film to the film structure.

### SUMMARY OF THE INVENTION

The invention disclosed herein includes a multi-layered film comprising at least a core layer comprising polypropylene; a metalizable skin layer; and a first tie layer comprising functionalized polypropylene between the core layer and metalizable skin layer; wherein the metalizable skin layer comprises a polymer having a surface energy (ASTM D2578) of at least 30 dynes/cm or 32 dynes/cm, a Young's Modulus (ASTM D790) of at least 1500 MPa or 1600 MPa or 2000 MPa, and a melting point (ASTM D3418) of at least 130° C. or 135° C. or 140° C.; and wherein the film as measured on the metalizable skin side has a Haze of less than 1000 or 900 or 800 or 750 Haze units, and a Gloss of greater than 300 or 350 or 400 Gloss units.

The invention also includes a method of improving metalized film appearance comprising providing a multi-layered film comprising at least:
a core layer comprising polypropylene;
a metalizable skin layer; and
a first tie layer comprising functionalized polypropylene between the core layer and metalizable skin layer;
   wherein the metalizable skin layer comprises a polymer having a surface energy (ASTM D2578) of at least 30 dynes/cm or 32 dynes/cm, a Young's Modulus (ASTM D790) of at least 1500 MPa or 1600 MPa or 2000 MPa, and a melting point (ASTM D3418) of at least 130° C. or 135° C. or 140° C.; followed by measuring the gloss and haze of the metalizable skin layer side of the film; adjusting the composition of the metalizable skin layer so that the metalizable skin side has a Haze of less than 1000 or 900 or 800 or 750 Haze units, and a Gloss of greater than 300 or 350 or 400 Gloss units; and metalizing the multi-layered film on the metalizable skin layer face.

### DETAILED DESCRIPTION

The present invention is directed to multi-layered films that are metalizable. In particular, the invention(s) disclosed herein are directed to an improved appearance of the metalized multi-layered film and improved adhesive strength between the skin layers of the film and the rest of the structure. The multi-layered films have at least a core layer of polypropylene, a metalizable skin layer, and a first tie layer therebetween, or an A/B/C structure (wherein “C” is the core layer and “A” is the metalizable skin). The improvements are achieved by selecting the metalizable skin layer, and/or its treatment method, such that the skin has the lowest possible haze and highest possible gloss, and also, or in the alternative, providing a first tie layer that strongly adheres the metalizable skin layer to the core layer. The latter is achieved using a functionalized polypropylene, and even more particularly, by using a functionalized polypropylene that excludes any rubber phase. An example of this is a maleic anhydride-grafted isotactic polypropylene. A surprising effect of this is that certain film properties such as the oxygen and water transmission rates are improved by such a tie layer.

Thus, described broadly herein is a multi-layered film comprising a core layer comprising polypropylene, a metalizable skin layer comprising a high surface energy polymer; and a first tie layer comprising functionalized polypropylene between the core layer and metalizable skin layer. Preferably, the metalizable skin layer comprises a polymer having a surface energy (ASTM D2578) of at least 30 dynes/cm or 32 dynes/cm, a Young's Modulus (ASTM D790) of at least 1500 MPa or 1600 MPa or 2000 MPa, and a melting point (ASTM D3418) of at least 130° C. or 135° C. or 140° C. Furthermore, the film as measured on the metalizable skin side has a Haze of less than 1000 or 900 or 800 or 750 Haze Units, and a Gloss of greater than 300 or 350 or 400 Gloss Units, those measurements made as described herein.

There may be additional layers to the film, especially a second skin layer that is sealable, and an optional second tie layer between the core layer and second skin layer. There may also be additional tie layers. Each of the layers may be of any desirable thickness such as from 1 or 2 μm to 20 or 30 μm, but the core layer is most preferably 8 or 10 μm to 16 or 20 or 24 μm, and the other layers are preferably from 1 or 2 μm to 5 or 8 μm. The films can be clear, or if they have a cavitation agent (e.g., polybutylene terephthalate or CaCO₃) and/or whitening agent (e.g., TiO₂), they will be opaque. When metalized, the multi-layered films will of course be mostly opaque even when the base film is clear. The films are preferably strong yet flexible and thus wrapable, formable, and conformable to desirable commercial products, especially food products.

The various descriptive elements and numerical ranges disclosed herein for the metalized film or method of making the metalized film can be combined with other descriptive elements and numerical ranges to describe the invention(s); further, for a given element, any upper numerical limit can be combined with any lower numerical limit described herein.

As used herein, “consisting essentially of” means that the layer or material referred to has no more than 5 wt % or 4 wt % or 3 wt % or 2 wt % or 1 wt % of “additives” or other materials that may alter its usefulness as the claimed feature. The “additives” include those materials known in the commercial films arts such as anti-block agents, anti-static agents, anti-slip agents, colorants, whiteners, fillers, cavitation agents, and nucleating agents.

### Metalizable Skin Layer

The metalizable skin layer (A) has a high surface energy and is relatively stiff (high modulus) and relatively crystalline (high melting point). The high energy is achieved by utilizing a material such as ethylene vinylalcohol or polylactic acid that possesses its own surface polarity by virtue of having groups such as oxygen or nitrogen in the polymer structure, by “treatment” such as exposing the outward facing surface to be metalized to oxidizing plasma and/or corona or sacrificial chemicals, or a combination of the two.

For example, low density polyethylene (LDPE) or high density polyethylene (HDPE) is often used as a metalizable skin layer. These materials benefit from being “treated” thus giving their outer or exposed surface a high surface energy. The metalizable skin layer, especially when it is a polymer comprising non-polar units, is preferably high-energy treated to increase its surface energy to greater than 30 or 35 or 40 or 45 dynes/cm, up to 50 or 60 dynes/cm. Any desirable technique may be used that is known in the art such as corona, plasma, flame, chemical (sacrificial, e.g., acid or peroxide), or other oxidative treatment. The gas that is used in the high-energy treatment can be air, or can be pure nitrogen, argon, water vapor, oxygen or carbon dioxide, or can be a mixture of any of these, preferably a mixture of nitrogen and oxygen, the oxygen present from 0.1% or 0.2% to 5% or 10% or 20% of the mixture. The conditions of the treatment can be tailored to the needs of the film, such as the length of time the film surface is exposed to the oxidizing gas, the energy imparted to the gas/plasma, and the gas mixture itself can be varied. The pretreatment is most preferably performed after orienting the film and before coating and/or metalizing the film.

The high surface energy polymer can also be any polymer that is formed as by lamination or extrusion coating into a thin film that inherently has a high surface energy, characterized as having a surface energy (ASTM D2578) of at least 30 dynes/cm or 32 dynes/cm with or without surface treatment; or preferably a surface energy within the range of from 30 or 32 to 40 or 45 or 50 or 60 dynes/cm with or without treatment. Ethylene vinyl alcohol and polyethylene terephthalate glycol are examples of high surface energy polymers.

In any case, the polymer that makes up the metalizable skin layer preferably has a Young's Modulus (ASTM D790) of at least 1500 MPa or 1600 MPa or 2000 MPa; or preferably a Young's Modulus within the range of from 1500 MPa to 5000 MPa or 10,000 MPa or 20,000 MPa. The high surface energy polymer also has a melting point (ASTM D3418) of at least 130° C. or 135° C. or 140° C., or preferably within the range of from 130° C. or 140° C. to 170° C. or 180° C. or 190° C.

Preferably, the metalizable skin layer is made from materials selected from treated LDPE, treated LLDPE, treated HDPE, nylon, polyester, ethylene vinyl alcohol copolymer (EvOH), polyethylene terephthalate, polyvinylchloride, acrylate-based polymers, methacrylate-based polymers, polyurethane, polyalkylimine (e.g., polyethyleneimine), acid-functionalized polyolefins (e.g., maleic anhydride or silane-grafted HDPE, LDPE, or iPP), polylactic acid, polyetherester-amide block copolymer, blends of any of these polymers, and treated versions of any of these materials. Of these, treated LDPE, treated HDPE, polylactic acid, polyester, and EvOH are particularly preferred.

Most preferably, the polymer used in the metalizable skin layer is a particular polyester: polyethylene terephthalate glycol (PETG) comprising within the range of from 40 or 45 wt % to 55 or 60 wt % terephthalic acid (TA) derived units, within the range of from 30 wt % to 40 wt % ethylene glycol (EG) derived units, within the range of from 5 or 8 wt % to 24 or 30 wt % cyclohexanedimethanol (CHDM) derived units, and within the range of from 1 wt % or 2 wt % or 4 wt % to 6 wt % diethylene glycol (DEG) derived units, all weight percentages by weight of the PETG.

Preferably, the metalizable skin layer comprises the polymers described here, and more preferably the metalizable skin layer consists essentially of these polymers, and most preferably consists of these polymers.

### Core Layer

The “polypropylene” of the core (C) layer of the multi-layered film to be metallized is a homopolymer or copolymer comprising from 60 wt % or 70 wt % or 80 wt % or 85 wt % or 90 wt % or 95 wt % or 98 wt % or 99 wt % to 100 wt % propylene-derived units (and comprising within the range of from 0 wt % or 1 wt % or 5 wt % to 10 wt % or 15 wt % or 20 wt % or 30 wt % or 40 wt % C₂ and/or C₄ to C₁₀ α-olefin derived units) and can be made by any desirable process using any desirable catalyst as is known in the art, such as a Ziegler-Natta catalyst, a metallocene catalyst, or other single-site catalyst, using solution, slurry, high pressure, or gas phase processes. Polypropylene copolymers are useful polymers in certain embodiments in the core or other film layer, especially copolymers of propylene with ethylene and/or butene, and comprise propylene-derived units within the range of from 70 wt % or 80 wt % to 95 wt % or 98 wt % by weight of the polypropylene. In any case, useful polypropylenes have a melting point (ASTM D3418) of at least 125° C. or 130° C. or 140° C. or 150° C. or 160° C., or within a range of from 125° C. or 130° C. to 140° C. or 150° C. or 160° C. A “highly crystalline” polypropylene is useful in certain embodiments, and is typically isotactic, and comprises 100 wt % propylene-derived units (propylene homopolymer), and has a relatively high melting point of from greater than (greater than or equal to) 140° C. or 145° C. or 150° C. or 155° C. or 160° C. or 165° C.

The term “crystalline,” as used herein, characterizes those polymers which possess high degrees of inter- and intra-molecular order. Preferably, the polypropylene has a heat of fusion (H_{f}) greater than 60 J/g or 70 J/g or 80 J/g, as determined by DSC analysis. The heat of fusion is dependent on the composition of the polypropylene; the thermal energy for the highest order of polypropylene is estimated at 189 J/g, that is, 100% crystallinity is equal to a heat of fusion of 189 J/g. A polypropylene homopolymer will have a higher heat of fusion than a copolymer or blend of homopolymer and copolymer. Also, the polypropylenes useful herein may have a glass transition temperature (ISO 11357-1, T_{g}) preferably between −20° C. or −10° C. or 0° C. to 10° C. or 20° C. or 40° C. or 50° C. Preferably, the polypropylenes have a Vicat softening temperature (ISO 306, or ASTM D1525) of greater than 120° C. or 110° C. or 105° C. or 100° C., or within a range of from 100° C. or 105° C. to 110° C. or 120° C. or 140° C. or 150° C., or a particular range of from 110° C. or 120° C. to 150° C.

Preferably, the polypropylene has a melt flow rate (“MFR,” 230° C., 2.16 kg, ASTM D1238) within the range of from 0.1 g/10 min or 0.5 g/10 min or 1 g/10 min to 4 g/10 min or 6 g/10 min or 8 g/10 min or 10 g/10 min or 12 g/10 min or 16 g/10 min or 20 g/10 min. Also, the polypropylene may have a molecular weight distribution (determined by GPC) of from 1.5 or 2.0 or 2.5 to 3.0 or 3.5 or 4.0 or 5.0 or 6.0 or 8.0, in certain embodiments. Examples of commercially available propylene polymers include, but are not limited to, Total 3371 (Total Petrochemicals Company), or PP4712 (ExxonMobil Chemical Company). An example of a suitable commercially available high crystallinity polypropylene (HCPP) is Total Polypropylene 3270, available from Total Petrochemicals.

Other film layers, such as the second tie layer, can comprise (or consist essentially of, or consist of) “polypropylene” as described above. The core layer may be any desirable thickness, and preferably has an average thickness within the range of from 10 or 20 or 30 or 40 to an upper limit of 50 or 60 or 100 or 150 or 200 μm. Thus, an exemplary average overall film thickness is from 30 to 60 μm. Preferably, the core layer comprises greater than 50 wt % or 70 wt % of the total weight of the film (all layers combined), and comprises greater than 80 wt % most preferably.

### First Tie Layer

The first tie layer (B) describes at least one layer that is between the core layer (C) and metalizable skin layer (A). Preferably, the first tie layer comprises (or consists essentially of, or consists of) functionalized polypropylene. A “functionalized polypropylene” is a polypropylene as described above that is useful in the core layer, except that it has been chemically functionalized (e.g., grafted) or otherwise has in its polymer backbone polar moieties such as oxygen, nitrogen, phosphorous, sulfur, silicon, and moieties that include such atoms (e.g., hydroxide, alkylsilane, acid anhydride, etc.). More preferably, the first tie layer comprises (consists essentially of, or consists of) a functionalized polypropylene excluding an elastomeric phase, which means that, for example, ethylene-propylene copolymer elastomers are absent from the functionalized polypropylene. Most preferably, the first tie layer comprises (or consists essentially of, or consists of) functionalized isotactic (crystalline) polypropylene.

Preferably, the functionalized polypropylene has a Vicat Softening Point (ASTM D1525) within the range of from 110° C. or 120° C. or 125° C. to 140° C. or 145° C. or 150° C. or 155° C. or 160° C. Preferably, such a functionalized polypropylene has a melting point of greater than 130° C. or 145° C. or 150° C. or 155° C., or within the range of from 130° C. or 145° C. or 150° C. to 155° C. or 160° C. or 165° C. Also, preferably the functionalized polypropylene having a Tensile Strength at Break (ASTM D638) of greater than 18 MPa or 20 MPa or 24 MPa or 26 MPa, or within the range of from 18 MPa or 20 MPa to 30 MPa or 40 MPa.

Preferably the first tie layer comprises (or consists essentially of, or consists of) an acid- or amine-functionalized polypropylene that may have the features described above. The acid or amine functionalities preferably comprise from 0.1 wt % to 0.3 wt % or 0.5 wt % or 1.0 wt % or 2.0 wt % or 5.0 wt % or 8 wt % or 10 wt % of the functionalized polymer. Most preferably the first tie layer comprises (or consists essentially of, or consists of) a maleic anhydride-grafted isotactic polypropylene having the features as described above. There are many commercial grades of such polymers, for example, Admer™ PP-type grades of functionalized polypropylenes.

### Additional Film Layers

The multi-layered films described herein may also include other layers. For example, there may be a second skin layer adjacent to the core layer opposite the metalizable skin layer, the second skin layer comprising a sealable polymeric material. Thus, the multi-layered film would have an A/B/C/E structure, where “E” is the second skin layer. There may also be an optional second tie layer “D” located between the core and second skin, forming a structure A/B/C/D/E. The second tie layer may comprise the same or different materials as the first tie layer. Examples of other tie layer materials useful in the second tie layer include polypropylene and propylene copolymers as described for the core layer.

Preferably, the second skin layer in the multi-layered films of the invention may include (or consist essentially of, or consist of) a polymer that is suitable for heat-sealing, solvent sealing, or bonding to itself when crimped between heated crimp-sealer jaws. Desirable polymers that make up the skin layers have a DSC melting point of from 120° C. or 125° C. or 130° C. to 150° C. or 160° C., a Shore D Hardness within the range of from 55 or 56 to 65 or 70, and a Flexural Modulus (ISO 178, ASTM D790) of at least 500 MPa or 600 MPa or 650 MPa, or in another embodiment, within the range of from 400 MPa or 500 MPa or 600 MPa to 800 MPa or 900 MPa or 1000 MPa or 1500 MPa or 2000 MPa. Commonly, suitable skin layer polymers include copolymers or terpolymers of ethylene, propylene, and butylene (e.g., EP copolymer, EB copolymer, and EPB terpolymer) and may have DSC melting points of less than 140° C. or 135° C., or within a range of from 100° C. to 135° C. or 140° C. In some preferred embodiments, the skin layers may also comprise a layer selected from propylene homopolymer, ethylene-propylene copolymer, butylene homopolymer and copolymer, ethylene vinyl acetate (EVA), metallocene-catalyzed propylene homopolymer, polyethylene (low, linear low, medium, or high), polyvinyl dichloride (PVdC), and combinations thereof. An example of a suitable EPB terpolymer is Japan Polypropylene Corp. propylene-based terpolymer 7510. In a particular embodiment, the skin layers consist essentially of one or more propylene-ethylene copolymers or propylene-ethylene-butylene terpolymers.

Preferably, the second skin layer comprises at least one polymer selected from the group consisting of a polyethylene (PE) polymer or copolymer, a polypropylene polymer or copolymer, an ethylene-propylene copolymer, an EPB terpolymer, a propylene-butylene (PB) copolymer, and combinations thereof. Preferably, the PE polymer is high-density polyethylene (HDPE), such as HD-6704.67 (ExxonMobil Chemical Company) or M-6211 or HDPE M-6030 (Equistar Chemical Company). A suitable ethylene-propylene copolymer is Total 8573 (Total). Preferred EPB terpolymers include Japan Polypropylene 7510 and 7794 (Japan Polypropylene Corp.). For coating and printing functions, the second skin layer may comprise a copolymer that has been surface treated as described above.

The second skin layer can also comprise (or consist essentially of, or consist of) a styrenic block copolymer. Desirable polymer will have a density within the range of from 0.850 g/cc or 0.860 g/cc or 0.870 g/cc to 0.930 g/cc or 0.940 g/cc or 0.960 g/cc or 1.000 g/cc or 1.050 g/cc (ISO 1183). Preferably, the styrenic block copolymers comprise from 15 wt % or 20 wt % or 25 wt % to 35 wt % or 40 wt % or 45 wt % or 50 wt % styrenic derived units, by weight of the copolymer. Preferably, the styrenic block copolymer is a styrene-ethylene/butylene-styrene terpolymer having a melt flow rate (MFR, ASTM D 1238, 230° C. at 2.16 kg) of from 0.5 g/10 min or 1 g/10 min or 2 g/10 min or 3 g/10 min to 6 g/10 min or 8 g/10 min or 10 g/10 min or 12 g/10 min. Desirable styrenic block copolymers may be SEBS or SBBS Tuftec™ styrenic elastomers from Asahi Kasei Chemicals; Chevron Phillips K-Resins™; and Kraton™ D or G elastomers.

There may be additional tie layers located between the core layer and the first and/or second tie layers. These layers preferably comprise a polyolefin homopolymer or copolymer, and may contain cavitating agents, whiteners, and other additives as described above. Thus, the multi-layered films of the invention may have an A/B/C structure, or A/B/C/D/E structure, or have more tie layers such as an A/B/T¹/C/D/E, A/B/C/T²/D/E, A/B/T¹/C/T²/D/E structure, wherein “T¹” and “T²” are each one, two, or three tie layers, each from 0.5 or 1 μm to 3 or 5 or 10 μm in thickness and made from materials as described herein, for the first and second tie layers.

### Method of Making Film and Improving Appearance

The inventive films are preferably biaxially oriented. The inventive films can be made and oriented by any suitable technique known in the art, such as a cast, tentered, blown process, LISIM™, and others. Further, the working conditions, temperature settings, lines speeds, etc., will vary depending on the type and the size of the equipment used. Nonetheless, described generally here is one method of making the films described throughout this specification. In a particular embodiment, the films are formed and biaxially oriented using the “tentered” method. In the tentered process, line speeds of greater than 100 m/min to 400 m/min or more, and outputs of greater than 2000 kg/hr to 4000 kg/hr or more are achievable. In the tenter process, sheets/films of the various materials are melt blended and coextruded, such as through a 3, 4, 5, 7-layer die head, into the desired film structure. Extruders ranging in diameters from 100 mm to 300 or 400 mm, and length to diameter ratios ranging from 10/1 to 50/1 can be used to melt blend the molten layer materials, the melt streams then metered to the die having a die gap(s) within the range of from 0.5 or 1 to an upper limit of 3 or 4 or 5 or 6 mm. The extruded film is then cooled using air, water, or both. Typically, a single, large diameter roll partially submerged in a water bath, or two large chill rolls set at 20° C. or 30° C. to 40° C. or 50° C. or 60° C. or 70° C. are suitable cooling means. As the film is extruded, an air knife and edge pinning are used to provide intimate contact between the melt and chill roll.

Downstream of the first cooling step in this embodiment of the tentered process, the unoriented film is reheated to a temperature of from 80° C. to 100° C. or 120° C. or 150° C. in one embodiment by any suitable means such as heated S-wrap rolls, and then passed between closely spaced differential speed rolls to achieve machine direction orientation (MDO or MDX) at from greater than 2 or 3 or 4 or 4.5 or 5 or 6 times; or within the range of from 1.5 or 2 or 3 to 5 or 6 or 7 or 8 times it original length. It is understood by those skilled in the art that this temperature range can vary depending upon the equipment, and in particular, upon the identity and composition of the components making up the film. Ideally, the temperature will be below that which will melt the film, or cause it to become tacky and adhere to the equipment, but high enough to facilitate the machine direction orientation process. Such temperatures referred to herein refer to the film temperature itself. The film temperature can be measured by using, for example, Infrared spectroscopy, the source aimed at the film as it is being processed; those skilled in the art will understand that for transparent films, measuring the actual film temperature will not be as precise. In this case, those skilled in the art can estimate the temperature of the film by knowing the temperature of the air or roller immediately adjacent to the film measured by any suitable means. The heating means for the film line may be set at any appropriate level of heating, depending upon the instrument, to achieve the stated film temperatures.

The film is stretched in the MD, preferably by differential roller speeds while the film is heated. The lengthened and thinned film is preferably cooled and passed to the tenter section of the line for TD orientation. At this point, the edges of the sheet are grasped by mechanical clips on continuous chains and pulled into a long, precisely controlled hot air oven for a pre-heating step. The film temperatures range from 100° C. or 110° C. to 150° C. or 170° C. or 180° C. in the pre-heating step. Again, the temperature will be below that which will melt the film or cause it to become tacky and adhere to the equipment, but high enough to facilitate the step of transverse direction orientation. Next, the edges of the sheet are grasped by mechanical clips on continuous chains and pulled into a long, precisely controlled hot air oven for transverse stretching. As the tenter chains diverge, a desired amount to stretch the film in the transverse direction, the film temperature is lowered by at least 2° C. but typically no more than 20° C. relative to the pre-heat temperature to maintain the film temperature so that it will not melt the film. After stretching to achieve TDO in the film, the film is then cooled from 5° C. to 10° C. or 15° C. or 20° C. or 30° C. or 40° C. below the stretching temperature, and the clips are released prior to edge trim, optional coronal, printing, and/or other treatment can then take place, followed by winding. Preferably, the films are stretched in both the MD and TD, most preferably MDX first followed by TDX, or simultaneously.

TD orientation may be achieved by the steps of pre-heating the film having been machine oriented, followed by stretching it at a temperature below the pre-heat temperature of the film, and then followed by a cooling step at yet a lower temperature. Preferably, the films described herein are formed by imparting a transverse orientation by a process of first pre-heating the film, followed by a decrease in the temperature of the film within the range of from 2° C. or 3° C. to 5° C. to 10° C. or 15° C. or 20° C. relative to the pre-heating temperature while performing transverse orientation of the film, followed by a lowering of the temperature within the range of from 5° C. to 10° C. or 15° C. or 20° C. or 30° C. or 40° C. relative to the stretching temperature, holding or slightly decreasing (by no more than 5%) the amount of stretch, to allow the film to “anneal.” The latter step imparts (reduces or minimizes) the high TD shrink characteristics of the films described herein, thus improving dimensional stability. Preferably, the dimensional stability of the films described herein is within 15% or 10% or 8% at 135° C. after 5 to 10 minutes in either the MD or TD as otherwise measured by ASTM D1204. Thus, for example, where the pre-heat temperature is 120° C., the stretch temperature may be 114° C., and the cooling step may be 98° C., or any temperature within the ranges disclosed. The steps are carried out for a sufficient time to affect the desired film properties as those skilled in the art will understand.

Thus, the invention also includes a method of improving metalized film appearance comprising first providing a multi-layered film as described herein, including at least a core layer comprising polypropylene; a metalizable skin layer; and a first tie layer comprising functionalized polypropylene between the core layer and metalizable skin layer; followed by measuring the gloss and haze of the metalizable skin layer side of the film. Next, the method includes adjusting the composition of the metalizable skin layer so that the metalizable skin side has a Haze of less than 1000 or 900 or 800 or 750 Haze Units, and a Gloss of greater than 300 or 350 or 400 Gloss Units. The multi-layered film with the metalizable skin layer to be adjusted may be different from the film that is “measured” for gloss, as in most instances the properties of the measured film are set. Thus, subsequent to “measuring”, the next film to be manufactured is measured, having been adjusted to meet the desired requirements. It is conceivable, however, that methods exist to adjust the films properties to the desirable level after measuring, while being manufactured.

The composition can be adjusted any number of ways such as by changing the level (wt %) of the high surface energy polymer that is used and/or changing its identity and/or changing the conditions of the treatment. For example, PETG may make up 100 wt % of the metalizable skin layer, or may be a blend with PP copolymer, LDPE, or HDPE having within the range of from 5 wt % or 10 wt % to 20 wt % or 30 wt % or 40 wt % or 50 wt % or 60 wt % PETG by weight of the blend, or other desirable range. Most preferably, the haze and gloss values of the metalized film are adjusted by changing/adjusting the identity of the metalizable skin layer itself, either changing the polymer, or adjusting the comonomer levels in a given polymer. These different polymers and comonomer levels are described above. Finally, the method includes metalizing the multi-layered film on the metalizable skin layer face.

Prior to metallization, the metalizable skin layer may be treated as described above to enhance its surface energy. Metalizing oriented polypropylene films is well known in the art and any suitable means may be used in the present invention. In general, a desirable metal is vaporized in an evacuated chamber and the film is unwound and the metalizable surface of the film is exposed for a time to the vaporized metal, allowing the metal to deposit on the film. Oxygen may be present to various levels to create a metal oxide surface, but preferably it is absent, thus creating a shiny appearance on the metalized film. In a preferred embodiment, the following process is used to metallize the film. A batch metallizer is an apparatus wherein a roll of polymeric film is loaded into the vacuum chamber having a series of trays or “boats,” preferably placed in a row that encompasses the width of the film to pass through the chamber. After loading and threading up the roll through the winding mechanism on the machine, the chamber is closed and placed under the appropriate vacuum pressure, which can be within the range of from 0.1 or 0.2 or 0.5 or 1 to 6 or 8 or 10 (each value, ×10-4) millibar (absolute). After the correct vacuum is reached, the intermetallic boats are heated by passing electricity through the boats. The boats are heated to a temperature within the range of from 1000° C. or 1100° C. or 1200° C. to 1500° C. or 1600° C. or 1700° C. in order to melt and vaporize the aluminum. Although aluminum is the preferred metal, other metals can be used and the temperature of the boats adjusted accordingly. The boats are approximately 3 to 5 inches apart in the transverse direction and are approximately 4 to 5 inches below the passing web of film. The film is then fed through the chamber at a rate within the range of from 1 or 2 or 5 to 15 or 20 meters/second. When the boats are at the correct operating temperature, metal wire, preferably aluminum wire is fed to each boat at a constant feed rate to effectuate the desired level of metallization. Of course, preferably the metal or metal oxide layer on the film is of a relatively even thickness throughout the length and width of the film, and may be of an optical density to allow optical scanners to see articles that are contained in packaging made from the metalized multi-layered films. Desirable commercial metalizers are sold, for example, by General Vacuum Equipment Ltd (Bobst Group).

The film structure upon metalizing the multi-layered film would be M/A/B/C, wherein “M” is the metal layer. This layer could be further treated by coating, such as coating with an ink receptive coating. Such coatings are well known in the art and are useful for printing upon the multi-layered metalized film.

### The Multi-Layered Film

The multi-layered films of the invention, whether metalized or non-metalized, have certain desirable properties. The non-metalized multi-layered film has a haze (ASTM D1003) of less than 10% or 8% or 5% or 3% and a Gloss (ASTM D2457) of greater than 70 or 80 or 90 or 95 gloss units. Low haze is preferably achieved in non-cavitated and non-whitened films.

The multi-layered films have an oxygen transmission rate (OTR), at 0% humidity, of less than 4 or 3 or 2 or 1 cm3/m2-day, or within a range of from 0.5 or 0.1 cm3/m2-day to 1 or 2 or 3 or 4 cm3/m2-day. Low OTR is preferably achieved in non-cavitated and non-whitened films.

The multi-layered films have a water vapor transmission rate (WVTR), at 90% humidity, of less than 4 or 3 or 2 or 1 g/m2-day, or within a range of from 0.5 or 0.1 g/m2-day to 1 or 2 or 3 or 4 g/m2-day. Low WVTR is preferably achieved in non-cavitated and non-whitened films.

The multi-layered films have a skin adhesion at peak strength, for the metalizable skin layer, of greater than 50 or 80 or 100 or 120 or 160 or 200 g/inch, or within a range of from 50 or 80 or 100 or 150 or 200 g/inch to 250 or 300 or 400 or 500 or 600 or 700 g/inch. Most preferably, the metalizable skin adhesion has a peak adhesion strength after MDX as stated, when the film is oriented in the machine direction (MDX) at greater than 2 or 3 or 4 or 4.5 or 5 or 6 times; or within the range of from 1.5 or 2 or 3 to 5 or 6 or 7 or 8 times.

The multi-layered films described herein are desirably used to package goods (or “articles”) such as food, in particular, candy bars or a plurality of smaller items together. The films can be used to package or “wrap” the goods in any number of ways. Preferably, process for packaging an article might include enclosing one or more articles in a package comprising a multi-layer, metallized film comprising at least one metalizable skin layer having an outside surface and an inside surface; and a metal layer deposited onto the outside surface of the skin layer; the film as described above. Any method may be used to wrap articles such as by using vertical or horizontal form, fit, and seal machinery.

The invention(s) is exemplified by the following non-limiting examples.

### EXAMPLES

Appearance of metalized films. A number of oriented polypropylene films, both non-metalized and metalized, having certain metalizable skins, were measured for Haze and Gloss. The metalizable skin layer was varied from film to film using certain high surface energy polymers. The Embrace™ 212F skins are polyethylene terephthalate glycol (PETG) “copolymers” comprising about 50 wt % terephthalic acid (TA) derived units, about 30 wt % to 39 wt % ethylene glycol (EG) derived units, about 8 wt % to 24 wt % cyclohexanedimethanol (CHDM) derived units, and about 4 wt % to 6 wt % diethylene glycol (DEG) derived units, all weight percentages by weight of the PETG. The Eastar™ 6763 skins are PETG “copolymers” comprising about 50 wt % terephthalic acid (TA) derived units, about 33 wt % ethylene glycol (EG) derived units, about 17 wt % cyclohexanedimethanol (CHDM) derived units, and about 1 wt % to 2 wt % diethylene glycol (DEG) derived units, all weight percentages by weight of the PETG. (See M. Kattan et al., 81 J. Appl. Polym. Sci. 3405-3412 (2001) and U.S. Pat. No. 6,362,306.) Terphane™ polyesters are PET homopolymers. Ingeo™ 4042-D is a polylactic acid polymer having a melting point of 150° C. used as a metalizable skin layer. “Experimental” 5-layer films were made using these metalizable skin layer materials comprising polypropylene homopolymer core layers and Admer™ AT-1179A (a maleic anhydride grafted isotactic polypropylene) tie layers between the skin and core. The metalizable skin layers were flame treated.

Haze and Gloss measurements were carried out on the Experimental and commercial grades of metalizable films. Model haze-gloss instrument from BYK-Gardner. This instrument measures reflectance haze and gloss at 20, 60, and 85 degrees. For mirror-like surfaces, it is recommended to measure the reflectance haze and 20 degree gloss. A black, felt backing was placed on the sample stage under the samples. Multiple locations were tested on one sheet of sample. Measurements were taken on the film in the MD unless otherwise stated. If the sample was large or visually very different, more locations were measured. The instrument specification lists haze repeatability at +/−1 HU (haze unit) and reproducibility at +/−7 HU. The haze measurement range is 10-2500 HU. The gloss repeatability is listed at +/−0.2 GU (gloss unit) and reproducibility at +/−0.5 GU. The gloss measurement range is 0-2000 GU. The results are presented in Table 1.

The inventor observed that the relative shiny appearance of the metalized film is consistent with the trend from high gloss/low haze to low gloss/high haze in both metalized and non-metalized surfaces. Thus, as a predictor for better shine in a metalized film, high gloss and low haze is best in the non-metalized film. In general, the use of the Embrace PETG resulted in more shiny metalized films. One of the Embrace films, upon inspection, was found to have pinholes in the PETG skin and this explains its poor performance.

TABLE 1
Improved Shiny Appearance of Metalized Films

| | | Film Description | Average | Average |
|---|---|---|---|---|
| Side | Film | (metalizable skin layer) | of Haze | of Gloss |
| Metalized | Commercial 1 | EvOH | 395 | 583 |
| | Commercial 2 | EvOH | 794 | 427 |
| | Commercial 3 | HDPE | 1223 | 397 |
| | Commercial 4 | EP copolymer | 901 | 488 |
| | Commercial 5 | HDPE | 740 | 540 |
| | Commercial 6 | LDPE | 496 | 557 |
| | Experimental 1 | Ingeo 4042-D (PLA) | 1095 | 547 |
| | Experimental 2 | Ingeo 4042-D (PLA) | 736 | 490 |
| | Experimental 3 | Embrace 212F (PETG) | 431 | 540 |
| | Experimental 4 | Eastar 6763 (PETG) | 956 | 496 |
| | Experimental 5 | Eastar 6763 (PETG) | 982 | 444 |
| | Experimental 6 | Eastar 6763 (PETG) | 1037 | 401 |
| | Experimental 7 | Eastar 6763 (PETG) | 609 | 666 |
| | Experimental 8 | Embrace 212F (PETG) | 1526 | 389 |
| | Commercial 7 | Terphane (PET) | 1166 | 397 |
| Non- | Commercial 1 | EvOH | 519 | 438 |
| metalized | Commercial 3 | HDPE | 1141 | 105 |
| | Commercial 4 | EP copolymer | 1071 | 377 |
| | Commercial 5 | HDPE | 1003 | 409 |
| | Commercial 6 | LDPE | 708 | 379 |
| | Experimental 1 | Ingeo 4042-D (PLA) | 1344 | 397 |
| | Experimental 2 | Ingeo 4042-D (PLA) | 1192 | 380 |
| | Experimental 3 | Embrace 212F (PETG) | 711 | 484 |
| | Experimental 4 | Eastar 6763 (PETG) | 1104 | 398 |
| | Experimental 5 | Eastar 6763 (PETG) | 985 | 386 |
| | Experimental 6 | Eastar 6763 (PETG) | 1507 | 201 |
| | Experimental 7 | Eastar 6763 (PETG) | 1168 | 348 |
| | Experimental 8 | Embrace 212F (PETG) | 1526 | 389 |
| | Commercial 7 | Terphane (PET) | 1261 | 315 |

Tie Layer material and skin adhesion. A number of oriented polypropylene films having various tie layers between the polypropylene core and the skin layer were tested for the adhesive strength of the skin. The structure of those films is in Tables 2, 3, and 4. In the tables, Admer™ QF-500 (“QF”) and QF-501 are comparative examples of maleic anhydride-grafted polypropylene comprising about 20 wt % EP rubber phase. Admer AT-1179 (“AT”) is as above, a MA-grafted iPP having a melting point of about 160° C. and a Vicat Softening Point of about 142° C. Orevac™ 18707 and 18732 are also MA-grafted iPPs with melting points of 152° C. and 134° C., respectively, and Vicat Softening Points of 123° C. and 120° C., respectively. Ingeo™ 4042D is a polylactic acid material and Eastar 6763 is defined above.

Water vapor transmission rate was measured by a reliable method, such as ASTM F1249. In particular, WVTR may be measured with a Mocon Permatran™ W600 instrument (available from Modern Controls, Inc., Elk River, Minn.) at 38° C. and 90% relative humidity. Oxygen Transmission Rate is determined in accordance with ASTM D 3985 at 73° F. (23° C.) and 0% relative humidity (RH). The skin-to-tie layer adhesion was tested using a Sintech Tensile Tester at 90° or 180°. The greater angle was used if no skin/tie layer separation was observed at the lower angle. Adhesive tape was applied to both faces of a one inch wide strip of the film to be tested. The sample is mounted into the tester and the test was performed at 12 inch/min pull rate. The interfacial adhesion is then reported as an average value as the tape was pulled in grams per inch. The tests in Table 3 were performed after MDX.

Opaque films (Films 3, 4, 25-30) have TiO2 and PBT in the core layer or an additional tie layer just adjacent to the core layer (between the core layer and first tie layer). The films are biaxially oriented prior to skin adhesion measurements and metallization, and their final thickness is about 30 μm. The metalizable (PETG) skins are flame or corona treated.

The results demonstrate that high melting point, high softening point MA-grafted iPP is advantageous over softer and rubber containing tie layer materials. Further, films with these tie layers have improved (reduced) oxygen and water permeability relative to films having EP rubber-containing tie layer materials.

TABLE 2
Improved Skin Adhesion for PP-MA Tie Layers

| | | | | | peak skin |
|---|---|---|---|---|---|
| | | | | | adhesion |
| Film | Gauge | Type | Skin | Tie layer | (g/in) |
| 1 | 130 | Clear | Eastar 6763 | Admer QF-500 | 94 |
| 2 | 130 | Clear | Eastar 6763 | Admer AT-1179 | 442 |
| 3 | 130 | Opaque | Eastar 6763 | Admer QF-500 | 134 |
| 4 | 130 | Opaque | Eastar 6763 | Admer AT-1179 | 349 |
| 5 | 95 | Clear | Eastar 6763 | Admer AT-1179 | 126 |
| 6 | 95 | Clear | Eastar 6763 | Admer QF-501 | 57 |
| 7 | 95 | Clear | Eastar 6763 | Admer QF-500 | 80 |
| 8 | 70 | Clear | Eastar 6763 | Admer AT-1179 | 73 |
| 9 | 70 | Clear | Eastar 6763 | Admer QF-500 | 10 |
| 10 | 50 | Clear | Eastar 6763 | Admer AT-1179 | 407 |
| 11 | 50 | Clear | Eastar 6763 | Orevac 18707 | 80 |
| 12 | 50 | Clear | Eastar 6763 | Orevac 18732 | 35 |
| 13 | 70 | Clear | Ingeo 4042D | Admer QF-501 | 88 |
| 14 | 70 | Clear | Ingeo 4042D | Admer AT-1179 | Could |
| | | | | | not initiate |
| 15 | 70 | Clear | Ingeo 4042D | Admer AT-1179 | 618 |
| 16 | 70 | Clear | Ingeo 4042D | Admer AT-1179 | 653 |

TABLE 3
Results of non-metalized and metalized PETG skin and various tie layers

| | | | | Non-metalized Films | | | | | |
|---|---|---|---|---|---|---|---|---|---|
| | | | | Percent | | | Bell Jar Metalized Films | | |
| | PETG | | | Haze | Avg. skin | Peak skin | OTR | OTR | WVTR |
| | thickness | Tie | | (ASTM | adhesion | adhesion | (0% RH) | (8% RH) | (90% RH) |
| Film | (μm) | layer | MDX | D1003) | (g/in) | (g/in) | (cm³/m²-day) | (cm³/m²-day) | (g/m²-day) |
| 17 | 2.68 | QF | 4.8 | 1.2 | 58.5 | 94.3 | 2.65 | 10.1 | 0.26 |
| 18 | 4.59 | QF | 4.8 | 1.4 | 35.2 | 57.2 | 7.07 | 13.4 | 1.14 |
| 19 | 2.55 | QF | 5.1 | 1.4 | 38.8 | 59.9 | 3.50 | 4.2 | 0.67 |
| 20 | 3.62 | QF | 5.1 | 1.1 | 57.8 | 102.7 | 4.52 | 7.3 | 0.54 |
| 21 | 2.20 | AT | 5.1 | 0.8 | 441.6 | 554.1 | 0.76 | 1.5 | 0.33 |
| 22 | 2.39 | AT | 4.8 | 0.7 | 335.2 | 442.7 | 0.46 | 0.7 | 0.21 |
| 23 | 3.66 | AT | 4.8 | 1.1 | 224.1 | 307.8 | 0.59 | 1.3 | 0.51 |
| 24 | 3.56 | AT | 5.1 | 0.7 | 397.4 | 464.9 | 7.38 | 6.9 | 0.47 |
| 25 | — | QF | 5.1 | 98.7 | 90.9 | 134.0 | 3.19 | 11.8 | 0.35 |
| 26 | — | AT | 4.8 | 97.6 | 183.5 | 290.3 | 38.4 | 56.0 | 1.45 |
| 27 | — | AT | 5.1 | 97.6 | 78.0 | 337.5 | 12.61 | 14.9 | 0.46 |
| 28 | — | AT | 5.1 | 98.8 | 117.3 | 349.3 | 1.67 | 5.2 | 0.23 |
| 29 | — | QF | 5.1 | 98.8 | 105.5 | 136.3 | 35.19 | 23.4 | 0.85 |
| 30 | — | QF | 4.8 | 98.5 | 75.3 | 106.6 | 15.5 | 18.7 | 0.77 |

TABLE 4
Skin adhesion properties of metalized Eastar ™ 6763 skin structures

| | | | Skin Adhesion | | | |
|---|---|---|---|---|---|---|
| | | | Before | | After | |
| | | | metalization | | metalization | |
| | Tie | PETG thickness | Average | Peak | Average | Peak |
| Film | layer | (μm) | (g/in) | (g/in) | (g/in) | (g/in) |
| 31 | AT | 2.0 | 124 | 232 | 96 | 157 |
| 32 | AT | 0.7 | — | — | 198 | 243 |
| 33 | QF | 1.3 | — | — | 44 | 92 |
| 34 | QF | 2.0 | 36, 25 | 78, 48 | — | — |
| 35 | AT | 2.0 | 88 | 126 | 200 | 279 |
| 36 | AT | 1.3 | — | — | 257 | 340 |
| 37 | QF | 1.3 | 84 | 180 | — | — |
| 38 | QF | 2.0 | 35 | 57 | 94 | 143 |
| 39 | AT | 2.0 | 231 | 327 | 323 | 380 |

Having described the various features of the multi-layered films and the method of improving their appearance upon metalization, set forth herein in numbered embodiments are:
1. A multi-layered film comprising:
   a core layer comprising polypropylene;
   a metalizable skin layer; and
   a first tie layer comprising functionalized polypropylene between the core layer and metalizable skin layer;
   wherein the metalizable skin layer comprises a polymer having a surface energy (ASTM D2578) of at least 30 dynes/cm or 32 dynes/cm, a Young's Modulus (ASTM D790) of at least 1500 MPa or 1600 MPa or 2000 MPa, and a melting point (ASTM D3418) of at least 130° C. or 135° C. or 140° C.; and
   wherein the film as measured on the metalizable skin side has a Haze of less than 1000 or 900 or 800 or 750 Haze Units, and a Gloss of greater than 300 or 350 or 400 Gloss Units.
2. The multi-layered film of numbered embodiment 1, wherein the first tie layer comprises (consists essentially of, or consists of) a functionalized polypropylene excluding an elastomeric phase.
3. The multi-layered film of numbered embodiments 1 or 2, wherein the first tie layer comprises (or consists essentially of, or consists of) an acid- or amine-functionalized polypropylene having a Vicat Softening Point (ASTM D1525) within the range of from 110° C. or 120° C. or 125° C. to 140° C. or 145° C. or 150° C. or 155° C. or 160° C.
4. The multi-layered film of any one of the previous numbered embodiments, wherein the first tie layer has a melting point of greater than 130° C. or 145° C. or 150° C. or 155° C.
5. The multi-layered film of any one of the previous numbered embodiments, wherein the first tie layer comprises (or consists essentially of, or consists of) a polypropylene having a Tensile Strength at Break (ASTM D638) of greater than 18 MPa or 20 MPa or 24 MPa or 26 MPa, or within the range of from 18 MPa or 20 MPa to 30 MPa or 40 MPa.
6. The multi-layered film of any one of the previous numbered embodiments, wherein the first tie layer comprises (or consists essentially of, or consists of) a maleic anhydride-grafted isotactic polypropylene.
7. The multi-layered film of any one of the previous numbered embodiments, wherein the metalizable skin layer comprises a layer selected from treated low density polyethylene, treated high density polyethylene, nylon, polyester, ethylene vinyl alcohol copolymer (EvOH), polyethylene terephthalate, polyvinylchloride, acrylate-based polymers, methacrylate-based polymers, polyurethane, polyalkylimine, acid-functionalized polyolefins, polylactic acid, polyetherester-amide block copolymer, and blends of any of these.
8. The multi-layered film of numbered embodiment 7, wherein the metalizable skin layer comprises polyethylene terephthalate glycol (PETG) comprising within the range of from 40 wt % or 45 wt % to 55 wt % or 60 wt % terephthalic acid (TA) derived units, within the range of from 30 wt % to 40 wt % ethylene glycol (EG) derived units, within the range of from 5 wt % or 8 wt % to 24 wt % or 30 wt % cyclohexanedimethanol (CHDM) derived units, and within the range of from 1 wt % or 2 wt % or 4 wt % to 6 wt % diethylene glycol (DEG) derived units, all weight percentages by weight of the PETG.
9. The multi-layered film of any one of the previous numbered embodiments, further comprising a second skin layer adjacent to the core layer opposite the metalizable skin layer, the second skin layer comprising a sealable polymeric material.
10. The multi-layered film of any one of the previous numbered embodiments, further comprising a layer of metal or metal oxide on the metalizable skin surface.
11. Packaging material comprising the multi-layered film of any one of the previous numbered embodiments.
12. A method of improving metalized film appearance comprising:
   (1) providing a multi-layered film of any one of the previous numbered embodiments;
   (2) measuring the gloss and haze of the metalizable skin layer side of the film;
   (3) adjusting the composition of the metalizable skin layer so that the metalizable skin side has a Haze of less than 1000 or 900 or 800 or 750 Haze Units, and a Gloss of greater than 300 or 350 or 400 Gloss Units; and
   (4) metalizing the multi-layered film on the metalizable skin layer face.
13. The method of numbered embodiment 12, prior to metalizing, orienting the multi-layered film in at least the machine direction (MDX) greater than 2 or 3 or 4 or 4.5 or 5 or 6 times; or within the range of from 1.5 or 2 or 3 to 5 or 6 or 7 or 8 times.
14. The method of numbered embodiment 12, wherein the composition of the metalizable skin layer is adjusted by changing the identity of the polymer making up the metalizable skin layer, changing the amount of the polymer making up the metalizable skin layer, adjusting the comonomer levels in a given polymer, or a combination of two or three of these methods.

Also disclosed is the use of a multi-layered film in food packaging of any one of the numbered Embodiments 1 to 10.

Also disclosed is the use of a HFFS or VFFS apparatus to form a package from the multi-layered film of any one of the numbered Embodiments 1 to 10.

1. A multi-layered film comprising:
a core layer comprising polypropylene;
a metalizable skin layer; and
a first tie layer comprising functionalized polypropylene between the core layer and metalizable skin layer;
wherein the metalizable skin layer comprises a polymer having a surface energy (ASTM D2578) of at least 30 dynes/cm, a Young's Modulus (ASTM D790) of at least 1500 MPa, and a melting point (ASTM D3418) of at least 130° C.; and
wherein the film as measured on the metalizable skin side has a Haze of less than 1000 Haze Units, and a Gloss of greater than 300 Gloss Units.

2. The multi-layered film of claim 1, wherein the first tie layer comprises a functionalized polypropylene excluding an elastomeric phase.

3. The multi-layered film of claim 1, wherein the first tie layer comprises an acid- or amine-functionalized polypropylene having a Vicat Softening Point (ASTM D1525) within the range of from 110° C. to 160° C.; and/or having a melting point of greater than 130° C.

4. The multi-layered film of claim 1, wherein the first tie layer comprises a polypropylene having a Tensile Strength at Break (ASTM D638) of greater than 18 MPa.

5. The multi-layered film of claim 1, wherein the first tie layer comprises a maleic anhydride-grafted isotactic polypropylene.

6. The multi-layered film of claim 1, wherein the metalizable skin layer comprises a layer selected from treated low density polyethylene, treated high density polyethylene, nylon, polyester, ethylene vinyl alcohol copolymer (EvOH), polyethylene terephthalate, polyvinylchloride, acrylate-based polymers, methacrylate-based polymers, polyurethane, polyalkylimine, acid-functionalized polyolefins, polylactic acid, polyetherester-amide block copolymer, and blends of any of these.

7. The multi-layered film of claim 6, wherein the metalizable skin layer comprises polyethylene terephthalate glycol (PETG) comprising within the range of from 40 wt % to 60 wt % terephthalic acid (TA) derived units, within the range of from 30 wt % to 40 wt % ethylene glycol (EG) derived units, within the range of from 5 wt % to 30 wt % cyclohexanedimethanol (CHDM) derived units, and within the range of from 1 wt % to 6 wt % diethylene glycol (DEG) derived units, all weight percentages by weight of the PETG.

8. The multi-layered film of claim 1, further comprising a second skin layer adjacent to the core layer opposite the metalizable skin layer, the second skin layer comprising a sealable polymeric material.

9. The multi-layered film of claim 1, further comprising a layer of metal or metal oxide on the metalizable skin surface.

10. Packaging material comprising the multi-layered film of claim 1.

11. A method of improving metalized film appearance comprising:
(1) providing a multi-layered film comprising:
(a) a core layer comprising polypropylene;
(b) a metalizable skin layer; and
(c) a first tie layer comprising functionalized polypropylene between the core layer and metalizable skin layer;
wherein the metalizable skin layer comprises a polymer having a surface energy (ASTM D2578) of at least 30 dynes/cm, a Young's Modulus (ASTM D790) of at least 1500 MPa, and a melting point (ASTM D3418) of at least 130° C.;
(2) measuring the gloss and haze of the metalizable skin layer side of the film;
(3) adjusting the composition of the metalizable skin layer so that the metalizable skin side has a Haze of less than 1000 Haze Units, and a Gloss of greater than 300 Gloss Units; and
(4) metalizing the multi-layered film on the metalizable skin layer face.

12. The method of claim 11, wherein the first tie layer comprises a functionalized polypropylene excluding an elastomeric phase.

13. The method of claim 11, wherein the first tie layer comprises an acid- or amine-functionalized polypropylene having a Vicat Softening Point (ASTM D1525) within the range of from 110° C. to 160° C.; and/or having a melting point of greater than 130° C.

14. The method of claim 11, wherein the first tie layer comprises a polypropylene having a Tensile Strength at Break (ASTM D638) of greater than 18 MPa.

15. The method of claim 11, wherein the first tie layer comprises a maleic anhydride-grafted isotactic polypropylene.

16. The method of claim 11, wherein the metalizable skin layer comprises a layer selected from treated low density polyethylene, treated high density polyethylene, nylon, polyester, ethylene vinyl alcohol copolymer (EvOH), polyethylene terephthalate, polyvinylchloride, acrylate-based polymers, methacrylate-based polymers, polyurethane, polyalkylimine, acid-functionalized polyolefins, polylactic acid, polyetherester-amide block copolymer, and blends of any of these.

17. The method of claim 16, wherein the metalizable skin layer comprises polyethylene terephthalate glycol (PETG) comprising within the range of from 40 wt % to 60 wt % terephthalic acid (TA) derived units, within the range of from 30 wt % to 40 wt % ethylene glycol (EG) derived units, within the range of from 5 wt % to 30 wt % cyclohexanedimethanol (CHDM) derived units, and within the range of from 1 wt % to 6 wt % diethylene glycol (DEG) derived units, all weight percentages by weight of the PETG.

18. The method of claim 11, further comprising a second skin layer adjacent to the core layer opposite the metalizable skin layer, the second skin layer comprising a sealable polymeric material.

19. The method of claim 11, prior to metalizing, orienting the multi-layered film in at least the machine direction (MDX) greater than 2 times.

20. The method of claim 11, wherein the composition of the metalizable skin layer is adjusted by changing the identity of the polymer making up the metalizable skin layer, changing the amount of the polymer making up the metalizable skin layer, adjusting the comonomer levels in a given polymer, or a combination of two or three of these methods.

21. Packaging material comprising the multi-layered film of claim 11.
